(19) United States
(12) Patent Application Publication
(10) Pub. No.: US 2012/0095179 A1
(43) Pub. Date: Apr. 19, 2012

(54) PYRROLINE-BASED NITROXIDE POLYMER AND BATTERY USING SAME

(75) Inventors: Hiroyuki Nishide, Tokyo (JP); Kenichi Oyaizu, Tokyo (JP); Takeshi Kawamoto, Tokyo (JP); Nobutaka Fujimoto, Hyogo (JP); Yuji Kinpara, Hyogo (JP); Shigeyuki Iwasa, Tokyo (JP); Kentaro Nakahara, Tokyo (JP)

(73) Assignees: WASEDA UNIVERSITY, Tokyo (JP); NEC CORPORATION, Tokyo (JP); SUMITOMO SEIKA CHEMICALS CO., LTD., Hyogo (JP)

(21) Appl. No.: 13/255,439

(22) PCT Filed: Mar. 5, 2010
(86) PCT No.: PCT/JP2010/053617

§ 371 Date: Nov. 17, 2011

(30) Foreign Application Priority Data
Mar. 12, 2009 (JP) 2009-059233

(51) Int. Cl. H01M 4/60; C08F 26/06

(52) U.S. Cl. 526/263

(57) ABSTRACT

The present invention provides a pyrroline nitroxide polymer, an electrode active material containing the polymer, and a cell utilizing the electrode active material.

The present invention is a pyrroline nitroxide polymer obtainable by polymerization of a pyrroline nitroxide compound represented by Formula (1).

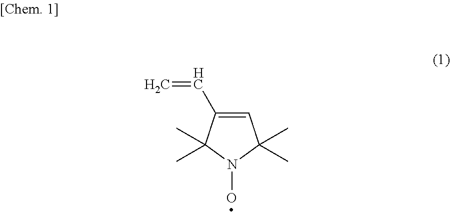

### TECHNICAL FIELD

The present invention relates to a pyrroline nitroxide polymer, an electrode active material containing the polymer, and a cell utilizing the electrode active material.

### BACKGROUND ART

Rapid market growth in the fields of laptop computers and mobile phones has demanded compact and high-capacity secondary cells with high energy density. To meet this demand, secondary cells have been developed which utilize an electrochemical reaction accompanying a charge transfer by alkali metal ions, such as lithium ions, serving as charge carriers. In particular, lithium ion secondary cells are used in various electronic machines and instruments as high-capacity secondary cells having high energy density and excellent stability. In such lithium ion secondary cells, a lithium-containing transition metal oxide is generally used as an active material for a cathode, and carbon as an active material for an anode. The lithium ion secondary cells are charged and discharged by utilizing insertion and elimination reactions of lithium ions into and from these active materials.

In recent years, a secondary cell utilizing a radical compound, as an electrode active material, which directly contributes to an electrode reaction have been proposed for the purpose of further increase in capacity. Patent Document 1 discloses a secondary cell containing a radical compound as an active material for at least one of a cathode and an anode. Further, Patent Document 2 discloses an electric condenser containing a nitroxyl compound in a cathode. This electric condenser is capable of charging and discharging a large amount of current because of its quick electrode response.

[Patent Document 1] Japanese Kokai Publication 2002-151084 (JP-A 2002-151084)

[Patent Document 2] Japanese Kokai Publication 2002-304996 (JP-A 2002-304996)

### DISCLOSURE OF THE INVENTION

### Problems to be Solved by the Invention

However, the capacity decrease after repetitive charge and discharge has been still to be remedied in the secondary cell containing a radical compound as an active material for at least one of a cathode and an anode (see Patent Document 1) and in the electric condenser containing a nitroxyl compound including a stable radical (see Patent Document 2).

The present invention is aimed to provide a pyrroline nitroxide polymer usable as an electrode material of a cell that is capable of providing large current and is subject to smaller capacity decrease even after repetitive charge and discharge, an electrode active material containing the polymer, and a cell utilizing the electrode active material.

### Means for Solving the Problems

The present invention relates to a pyrroline nitroxide polymer obtainable by polymerization of a pyrroline nitroxide compound represented by Formula (1).

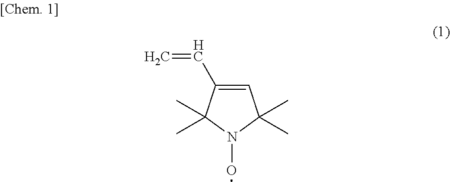

The present invention also relates to an electrode active material containing the pyrroline nitroxide polymer.

The present invention also relates to a cell utilizing the electrode active material.

Hereinafter, the present invention is described in detail.

The pyrroline nitroxide polymer according to the present invention is obtainable by polymerization of a pyrroline nitroxide compound containing a vinyl group represented by Formula (1).

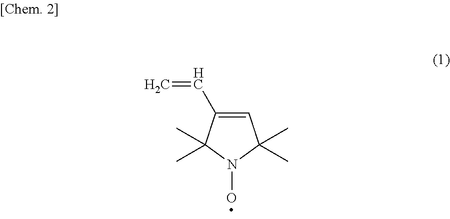

The pyrroline nitroxide polymer represented by Formula (1) is produced by a method using 3-carbamoyl-2,2,5,5-tetramethylpyrroline-1-oxyl (CAN. J. CHEM., 64, 1482-1490 (1986)) as shown by Formula (2). Specifically, 3-carbamoyl-2,2,5,5-tetramethylpyrroline-1-oxyl is hydrolyzed with an aqueous sodium hydroxide solution and the like to give 3-carboxy-2,2,5,5-tetramethylpyrroline-1-oxyl. Then, the obtained 3-carboxy-2,2,5,5-tetramethylpyrroline-1-oxyl is reduced with lithium aluminum hydride-tert-butoxide and the like under an inert gas atmosphere such as argon gas and nitrogen gas to give 3-formyl-2,2,5,5-tetramethylpyrroline-1-oxyl. The obtained 3-formyl-2,2,5,5-tetramethylpyrroline-1-oxyl is vinylated with methyl triphosphonium bromide and the like to give 3-vinyl-2,2,5,5-tetramethylpyrroline-1-oxyl.

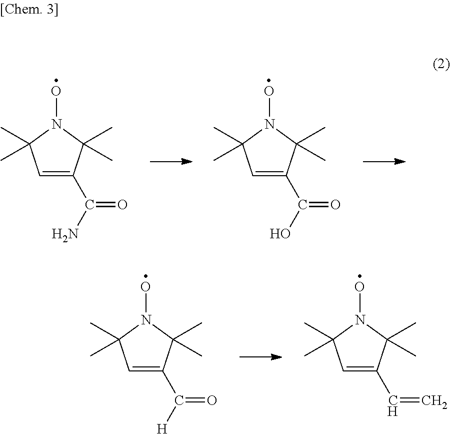

The pyrroline nitroxide polymer according to the present invention is obtainable by polymerization of the pyrroline nitroxide compound.

A method of polymerizing the pyrroline nitroxide compound is not particularly limited, and may be a polymerization method using a bulk polymerization process, a solution polymerization process, and the like.

The polymerization method using a bulk polymerization process includes the following steps, for example. A predetermined amount of a pyrroline nitroxide compound is fed into a reaction vessel equipped with a stirrer, a thermometer, a gas inlet tube for introducing an inert gas such as argon gas and nitrogen gas, and a condenser tube. After deoxygenation using an inert gas, a polymerization initiator is added to the vessel with stirring to initiate the polymerization.

The polymerization method using a solution polymerization process includes the following steps, for example. In the polymerization using a bulk polymerization process, an inert solvent is fed together with a predetermined amount of a pyrroline nitroxide compound. After deoxygenation using an inert gas, a polymerization initiator is added to the vessel with stirring to initiate the polymerization.

Examples of the inert solvent used in the polymerization using a solution polymerization process include: aromatic hydrocarbon solvents such as benzene, toluene, and xylene; saturated acyclic hydrocarbon solvents such as n-hexane, n-heptane, and ligroin; cyclic saturated hydrocarbon solvents such as cyclopentane, methylcyclopentane, cyclohexane, and methylcyclohexane; ether solvents such as diethyl ether, and tetrahydrofuran. Here, aromatic hydrocarbon solvents, saturated acyclic hydrocarbon solvents, and ether solvents are preferable among these because they are readily available on an industrial scale at reasonable cost, and capable of producing a polymerization reaction product reliable in quality. In particular, toluene, n-hexane, and tetrahydrofuran are preferable.

Though not particularly limited, the amount of the inert solvent used in the polymerization using a solution polymerization process is preferably 1 to 200 parts by weight for each 100 parts by weight of a pyrroline nitroxide compound from the standpoint of smooth progress of the reaction and the reasonable effect for the amount.

The polymerization initiator is not particularly limited and may be anionic polymerization initiator, for example. Examples of the anionic polymerization initiator include Ziegler-Natta reagents such as cyclopentadienyl titanium (IV)/methylaluminoxane, trichloro titanium (III)/triethylaluminum, tetrachlore titanium (IV)/triethylaluminum, trichloro vanadium (III)/triethylaluminum, dichloro cobalt (II)/pyridine/diethyl aluminum chloride; tert-butoxy potassium; Grignard reagents such as n-butyl magnesium bromide, isobutyl magnesium bromide, tert-butyl magnesium bromide, n-butyl magnesium chloride, isobutyl magnesium chloride, and tert-butyl magnesium chloride; alkyl lithium such as n-butyl lithium, tert-butyl lithium, and 1,1-diphenyl hexyl lithium; and diethyl zinc or diethyl zinc/water initiators. Here, Ziegler-Natta reagents are preferably used among these because they produce a polymerization reaction product reliable in quality. In particular, cyclopentadienyl titanium (IV) trichloride/methylaluminoxane initiators are preferable.

The amount of the polymerization initiator is dependent on the type of the polymerization initiator to be used and the reaction temperature. Commonly, the amount is preferably 0.00005 to 10 parts by weight for each 100 parts by weight of a pyrroline nitroxide compound. In the polymerization reaction, a chain transfer agent such as isopropyl alcohol and a polymerization terminator such as methanol may be appropriately added if needed.

The reaction temperature is dependent on the type of the polymerization initiator to be used. Commonly, the reaction temperature is preferably −100° C. to 100° C., and more preferably −20° C. to 80° C. The reaction time is dependent on the reaction temperature and is commonly 5 to 60 hours.

Thus obtained pyrroline nitroxide polymer can be isolated by mixing the reaction liquid with a solvent, for example, an aliphatic hydrocarbon solvent such as hexane and filtering the precipitated polymerization reaction product. Further, methanol, hexane, and the like may be used to remove unreacted matters and rinse the pyrroline nitroxide polymer. Additionally, dilute hydrochloric acid, water and the like may be used to remove the residual polymerization initiator and rinse the resulting pyrroline nitroxide polymer. The obtained pyrroline nitroxide polymer may be then dried. The pyrroline nitroxide polymer is thus purified.

The pyrroline nitroxide polymer according to the present invention may have a crosslinked structure. To produce such pyrroline nitroxide polymer having a crosslinked structure, a crosslinking agent is added in the polymerization of the pyrroline nitroxide compound so as to copolymerize with the compound.

The crosslinking agent is not particularly limited, provided that it is a compound having a plurality of polymerizable unsaturated groups in the molecule. Examples thereof include (meth)acrylic acid polyfunctional compounds, allyl ether polyfunctional compounds, and vinyl polyfunctional compounds. Specific examples of the (meth)acrylic acid polyfunctional compounds include ethylene glycol di(meth)acrylate, diethylene glycol di(meth)acrylate, polyethylene glycol di(meth)acrylate, 1,3-propanediol di(meth)acrylate, 1,3-butanediol di(meth)acrylate, 1,4-butanediol di(meth)acrylate, 1,5-pentanediol di(meth)acrylate, 1,6-hexanediol di(meth)acrylate, 1,7-heptanediol di(meth)acrylate, 1,8-octanediol di(meth)acrylate, 1,9-nonanediol di(meth)acrylate, 1,10-decanediol di(meth)acrylate, trimethylolpropane tri(meth)acrylate, glycerol di(meth)acrylate, and 2-hydroxy-3-(meth)acryloyloxy-propyl(meth)acrylate. Specific examples of the allyl ether polyfunctional compounds include diethylene glycol diallyl ether and dibutylene glycol diallyl ether. Specific examples of the vinyl polyfunctional compounds include divinyl benzene. Among these, the (meth)acrylic acid polyfunctional compounds are preferably used because of their high polymerization reactivity. Further, ethylene glycol di(meth)acrylate, 1,4-butanediol di(meth)acrylate, 1,6-hexanediol di(meth)acrylate, 1,8-octanediol di(meth)acrylate, and 1,9-nonanediol di(meth)acrylate are particularly preferable. Each of these crosslinking agents may be used alone, or two or more of these may be used in combination. In the present description, “(meth)acrylic” refers to “acrylic” and “methacrylic”.

The ratio of the crosslinking agent to the pyrroline nitroxide compound is not particularly limited. The crosslinking agent is preferably 0.00001 to 0.25 moles, more preferably 0.00005 to 0.1 moles, and further preferably 0.0001 to 0.05 moles, to one mole of the pyrroline nitroxide compound.

The pyrroline nitroxide compound according to the present invention has a number average molecular weight of preferably 500 to 5,000,000 and more preferably of 1,000 to 1,000,000. When the number average molecular weight is less than 500, the pyrroline nitroxide polymer is dissolved in an electrolyte solution. This may decrease the capacity of cells utilizing the electrode active material containing such pyrroline nitroxide polymer. In contrast, when the number average molecular weight is more than 5,000,000, such polymers may have poor handleability. Here, the number average molecular weight refers to the standard polystyrene equivalent measured by gel permeation chromatography.

The electrode active material according to the present invention contains the pyrroline nitroxide polymer according to the present invention. The present invention also provides such an electrode active material.

In addition, the cell according to the present invention utilizes the electrode active material according to the present invention. The present invention also provides such a cell.

FIG. 1 illustrates one embodiment of the cell according to the present invention. The cell illustrated in FIG. 1 has a configuration in which a cathode 5 and an anode 3 are stacked to face each other with a separator 4 containing an electrolyte interposed therebetween, and a cathode current collector 6 is stacked in contact with the cathode 5. This stack is covered with a stainless steel covering 1 on the anode side and a stainless steel covering 1 on the cathode side. Between the two coverings 1, an insulating gasket 2 made of an insulating material, such as plastic resins, is arranged with an aim of avoiding electrical contact between the coverings. In the case that solid electrolytes or gel electrolytes are used, these electrolytes may be, instead of the separator 4 containing an electrolyte, interposed between the electrodes.

The electrode active material according to the present invention may be used in the anode 3, the cathode 5, or the both electrodes in such a cell. The cell according to the present invention utilizes the electrode active material according to the present invention as the electrode active material in the anode 3, the cathode 5, or the both electrode.

Hereinafter, description is given on main components constituting the cell.

### (1) Electrode Active Material

The term “an electrode active material” in the present invention refers to a material which directly contributes to the electrode reaction such as charging and discharging and plays a central role in the cell system.

The electrode active material according to the present invention contains the pyrroline nitroxide polymer according to the present invention. The electrode active material used in the cathode and/or the anode may contain the pyrroline nitroxide polymer according to the present invention solely or in combination with another electrode active material.

In the case that the pyrroline nitroxide polymer according to the present invention is used in the electrode active material for the cathode, examples of another electrode active material include metal oxides, disulphide compounds, other stable radical compounds, and conductive polymers.

Examples of the metal oxides include: lithium manganate such as LiMnO₂, LiₓMn₂O₄ (0<x<2), lithium manganate having a spinel structure; MnO₂; LiCoO₂; LiNiO₂; Li_{y}V₂O₅ (0<y<2); olivine materials such as LiFePO₄; materials in which Mn in the spinel structure is partially replaced with another transition metal such as LiNi_{0.5}Mn_{1.5}O₄, LiCr_{0.5}Mn_{1.5}O₄, LiCo_{0.5}Mn_{1.5}O₄, LiCoMnO₄; LiNi_{0.5}Mn_{0.5}O₂; LiNi_{0.33}Mn_{0.33}Co_{0.33}O₂; LiNi_{0.8}Co_{0.2}O₂; and LiN_{0.5}Mn_{1.5-z}Ti_{z}O₄ (0<z<1.5).

Examples of the disulphide compounds include dithioglycol, 2,5-dimercapto-1,3,4-thiadiazole, and S-triazine-2,4,6-trithiole.

Examples of the other stable radical compounds include poly(2,2,6,6-tetramethylpiperidinoxyl-4-yl methacrylate).

Examples of the conductive polymers include polyacetylene, polyphenylene, polyaniline, and polypyrrole.

Lithiun manganate and LiCoO₂ are preferably used among these. Each of these other electrode active materials may be combined with the pyrroline nitroxide polymer alone, or two or more of these may be together combined with the pyrroline nitroxide polymer in combination.

In the case that the pyrroline nitroxide polymer according to the present invention is used in the electrode active material for the anode, examples of another electrode active material include graphites, amorphous carbons, metal lithium, lithium alloys, lithium ion-storing carbons, metallic sodium, other stable radical compounds, and conductive polymers.

Examples of the other stable radical compounds include poly(2,2,6,6-tetramethylpiperidinoxyl-4-yl methacrylate).

In particular, a combination of metal lithium and graphites is preferable. Here, the form of these other electrode active material is not particularly limited, and may be thin film, bulk, packed powder, fibrous, or flaky. Each of these may be combined with the pyrroline nitroxide polymer alone, or two or more of these may be together combined with the pyrroline nitroxide polymer in combination.

The cell according to the present invention utilizes the electrode active material containing the pyrroline nitroxide polymer according to the present invention as the electrode active material for one of the cathode and anode, or for the both electrodes. In the case that the electrode active material containing the pyrroline nitroxide polymer according to the present invention is used only for one electrode, any of conventionally known electrode active materials listed as other electrode active materials maybe used as the electrode active material for the other electrode.

In the present invention, from the standpoint of the energy density, the electrode active material containing the pyrroline nitroxide polymer is preferably used for the cathode. Further, the pyrroline nitroxide polymer is preferably used alone, not in combination with another electrode active material. In this case, the electrode active material for the anode is preferably metal lithium or graphite.

### (2) Conductivity Imparting Agent (Auxiliary Conductive Material) and Auxiliary Ion-Conducting Material

In the case that the electrode active material according to the present invention is used in the cathode, a conductivity imparting agent (auxiliary conductive material) and/or an auxiliary ion-conducting material may be used in combination with an aim of lowering the impedance and improving the energy density and output characteristics.

Examples of the auxiliary conductive material include: carbonaceous fine particles such as graphite, carbon black, and acetylene black; carbon fibers such as vapor-grown carbon fiber (VGCF) and carbon nanotube; and conductive polymers such as polyaniline, polypyrrole, polythiophene, polyacetylene, and polyacene.

Examples of the auxiliary ion-conducting material include polymer gel electrolytes and polymer solid electrolytes. Among these, carbon fibers are preferably used. In particular, vapor-grown carbon fiber is more preferably used. Use of carbon fibers enhances the tensile strength of the electrode. In such a case, the electrodes are less likely to have clacks or to peel off. Each of these auxiliary conductive materials and the auxiliary ion-conducting materials may be used alone, or two or more of these may be used in combination.

In the case that the auxiliary conductive materials and/or the auxiliary ion-conducting materials are used, the proportion in the electrode is preferably 10% to 80% by weight.

### (3) Binding Agent

The electrode active material according to the present invention may be blended with a binding agent for the purpose of stronger binding of components.

Examples of the binding agent include resin binders such as polytetrafluoroethylenes, polyvinylidene fluorides, vinylidene fluoride-hexafluoropropylene copolymers, vinylidene fluoride-tetrafluoroethylene copolymers, styrene-butadiene copolymer rubbers, polypropylenes, polyethylenes, polyimides, and various polyurethanes. Each of these binding agents maybe used alone, or two or more of these may be used in combination.

In the case that the binding agent is used, the proportion in the electrode is preferably 5% to 30% by weight.

### (4) Viscosifier

A viscosifier may be used for easy preparation of slurry for producing the electrode active material according to the present invention.

Examples of the viscosifier include carboxymethylcellulose, polyethylene oxide, polypropylene oxide, hydroxyethyl cellulose, hydroxypropyl cellulose, carboxymethyl hydroxyethyl cellulose, polyvinyl alcohol, polyacrylamide, hydroxyethyl polyacrylate, ammonium polyacrylate, and sodium polyacrylate. Each of these viscosifiers may be used alone, or two or more of these may be used in combination.

In the case that the viscosifier is used, the proportion in the electrode is preferably 0.1% to 5% by weight.

### (5) Catalyst

In the electrode active material according to the present invention, a catalyst supporting a redox reaction may be blended for a smoother electrode reaction.

Examples of the catalyst include: conductive polymers such as polyaniline, polypyrrole, polythiophene, polyacetylene, and polyacene; basic compounds such as pyridine derivatives, pyrrolidone derivatives, benzimidazole derivatives, benzothiazole derivatives, and acridine derivatives; and metal ion complexes. Each of these catalysts may be used alone, or two or more of these may be used in combination.

In the case that the catalyst is used, the proportion in the electrode is preferably 10% by weight or less.

### (6) Current Collector and Separator

Examples of the current collector used in contact with the electrode active material according to the present invention include nickel, aluminum, copper, gold, silver, aluminum alloys, stainless steel, and carbons. The shape thereof may be foils, metal plates, meshes, and the like. The current collector may be provided with a catalytic effect, or the current collector may be chemically bound to the electrode active material.

Examples of the separators include a porous film and an unwoven fabric which are made of polyethylene, polypropylene, and the like.

### (7) Electrolyte

In the cell according to the present invention, the electrolyte conducts charge carrier transport between the anode and the cathode and preferably has an ion conductivity of 10⁻⁵ to 10⁻¹ S/cm at 20° C. Examples of the electrolyte include an electrolyte solution constituted by a solvent dissolving electrolyte salts therein.

The electrolyte salts may be conventionally known materials such as LiPF₆, LiClO₄, LiBF₄, LiCF₃SO₃, Li(CF₃SO₂)₂N, Li(C₂F₅SO₂)₂N, Li(CF₃SO₂)₃C, and Li(C₂F₅SO₂)₃C. Each of these electrolyte salts may be used alone, or two or more of these may be used in combination.

Examples of the solvent include organic solvents such as ethylene carbonate, propylene carbonate, dimethyl carbonate, diethyl carbonate, methylethyl carbonate, γ-butyrolactone, tetrahydrofuran, dioxolane, sulfolane, N,N-dimethylformamide, N,N-dimethylacetamide, and N-methyl-2-pyrrolidone. Each of these solvents may be used alone, or two or more of these may be used in combination.

In addition, solid electrolyte may be used as the electrolyte. Examples thereof include a polymer compound containing the electrolyte salts and a gelled polymer compound containing the electrolyte solution.

Examples of the polymer compounds include: vinylidene fluoride polymers; acrylonitrile polymers; polyethylene oxide, ethylene oxide-propylene oxide copolymers, and polymers of acrylates or methacrylates thereof. Specific examples of the vinylidene fluoride polymers include polyvinylidene fluorides, vinylidene fluoride-hexafluoropropylene copolymers, vinylidene fluoride-ethylene copolymers, vinylidene fluoride-monofluoroethylene copolymers, vinylidene fluoride-trifluoroethylene copolymers, vinylidene fluoride-tetrafluoroethylene copolymers, and vinylidene fluoride-hexafluoropropylene-tetrafluoroethylene ternary copolymers. Specific examples of the acrylonitrile polymers include acrylonitrile-methyl methacrylate copolymers, acrylonitrile-methyl acrylate copolymers, acrylonitrile-ethylmethacrylate copolymers, acrylonitrile-ethylacrylate copolymers, acrylonitrile-methacrylic acid copolymers, acrylonitrile-acrylic acid copolymers, and acrylonitrile-vinyl acetate copolymers.

### (8) Cell Shape

The shape of the cell according to the present invention is not particularly limited, and conventionally known shape may be employed. Exemplary cells include a cell constituted by an electrode stack or rolled electrodes which are sealed in a metal- or resin covering or sealed with a laminate film made of a synthetic resin film and a metal foil such as an aluminum foil. The shape thereof maybe a cylinder, square, coin, sheet, or the like.

### (9) Method of Producing Cell

A method of producing the cell according to the present invention is not particularly limited, and a proper method in accordance with the material may be employed. Exemplary method includes the steps of preparing a slurry by adding a solvent to a conductivity imparting agent and the electrode active material according to the present invention, or the like, applying the slurry to electrode current collectors, volatilizing the solvent under heating or at room temperature to produce electrodes, polarizing the obtained electrodes to have opposite polarities, stacking or rolling the electrodes with an separator interposed therebetween, wrapping the stack or roll with a covering material, injecting an electrolyte solution thereto, and sealing it. Examples of the solvent used for slurrying include: ether solvents such as tetrahydrofuran, diethyl ether, ethylene glycol dimethyl ether, and dioxane; amine solvents such as N,N-dimethylformamide, and N-methyl-2-pyrrolidone; aromatic hydrocarbon solvents such as benzene, toluene, and xylene; aliphatic hydrocarbon solvents such as hexane and heptane; halogenated hydrocarbon solvents such as chloroform, dichloromethane, dichloroethane, trichloroethane, and carbon tetrachloride; alkyl ketone solvents such as acetone, and methyl ethyl ketone; alcohol solvents such as methanol, ethanol, and isopropyl alcohol; dimethyl sulfoxide; and water. Another method of producing electrodes includes the steps of: dry-mixing an electrode active material, a conductivity imparting agent, and the like; and forming the resulting material into a thin film; and stacking the film on an electrode current collector.

In the method of producing the cell according to the present invention, the compound constituting the electrode active material is the pyrroline nitroxide polymer itself or a polymer to be modified to the pyrroline nitroxide polymer in the electrode reaction. Examples of the polymer to be modified to the pyrroline nitroxide polymer in the electrode reaction include a lithium or sodium salt constituted by anions reduced from the pyrroline nitroxide polymer and an electrolyte cations such as lithium ion and sodium ion, and salts constituted by cations produced by oxidizing the pyrroline nitroxide polymer and electrolyte anions such as PF₆⁻ and BF₄⁻.

In the cell according to the present invention, other production conditions with regard to drawing of a lead from the electrode, covering, and the like may be in accordance with a method conventionally known as a method of producing a cell.

### Effect of the Invention

The present invention provides a pyrroline nitroxide polymer usable as an electrode material of a cell that is capable of providing large current and is subject to smaller capacity decrease even after repetitive charge and discharge, an electrode active material containing the polymer, and a cell utilizing the electrode active material.

### BRIEF DESCRIPTION OF DRAWING

FIG. 1 is a schematic diagram illustrating one embodiment of the cell according to the present invention.

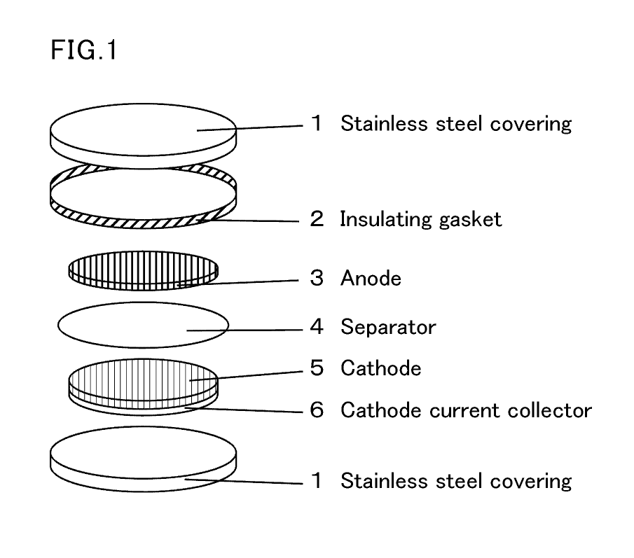

### MODES FOR CARRYING OUT THE INVENTION

The present invention is now specifically described with reference to Production Examples and Examples, but is not limited to these Production Examples and Examples.

### PRODUCTION EXAMPLE 1

### Production of Pyrroline Nitroxide Compound

A 100-mL four-neck flask equipped with a stirrer, a thermometer, a reflux condenser tube, and a flow meter was charged with 1.17 g of 3-carbamoyl-2,2,5,5-tetramethylpyrroline-1-oxyl and 16.8 mL of a 10 wt % aqueous sodium hydroxide solution. The mixture was suspended and allowed to stand for two hours at 100° C. Then, an appropriate amount of dilute hydrochloric acid was added thereto to neutralize the mixture. In this manner, a yellow solution was obtained. The solution was added with 50 mL of diethyl ether and extraction was carried out. The extracted substance was concentrated to give 1.12 g of 3-carboxy-2,2,5,5-tetramethylpyrroline-1-oxyl in the form of yellow crystals.

Because of the following properties, the obtained 3-carboxy-2,2,5,5-tetramethylpyrroline-1-oxyl could be identified.

IR (KBr): 3300, 2500, 1707 cm⁻¹

Molecular mass (Mass analysis by atmospheric pressure ionization method): 184

An amount of 1 g of the obtained 3-carboxy-2,2,5,5-tetramethylpyrroline-1-oxyl was fed into a 100-mL four-neck flask equipped with a stirrer, an argon-gas inlet tube, and a thermometer. Here, the flask was preliminary purged with argon gas. A mixed solvent containing 12 mL of benzene and 0.44 mL of pyridine was added thereto to dissolve the 3-carboxy-2,2,5,5-tetramethylpyrroline-1-oxyl. Next, the solution was cooled to 5° C. under argon atmosphere, and 0.44 mL of sulfur oxychloride and 2 mL of benzene were added thereto. After stirring for one hour, the solvent was removed and 10 mL of THF was added thereto to be dissolved therein. Then, the solution was cooled to −78° C., and 5.4 mL of 1 mol/L lithium aluminum hydride-tert-butoxide THF solution was dropped thereto over a two hour period. Extraction using 50 mL of ethyl acetate and subsequent concentration of the extracted substance gave 0.44 g of 3-formyl-2,2,5,5-tetramethylpyrroline-1-oxyl in the form of yellow crystals.

Because of the following properties, the obtained 3-formyl-2,2,5,5-tetramethylpyrroline-1-oxyl could be identified.

IR (KBr): 2834, 2736, 1688 cm⁻¹

Molecular mass (Mass analysis by atmospheric pressure ionization method): 168

A 100-mL four-neck flask equipped with a stirrer, an argon-gas inlet tube, and a thermometer was charged with 3.19 g of methyltriphosphonium bromide, 1.36 g of potassium carbonate, and 8.4 mL of tetrahydrofuran. Here, the flask was preliminary purged with argon gas. The charged substances were dissolved and allowed to stand for 30 minutes. Then, 0.50 g of 3-formyl-2,2,5,5-tetramethylpyrroline-1-oxyl and 2.3 mL of tetrahydrofuran were added thereto. The mixture was stirred for 48 hours at 25° C. and then added with 50 ml of diethyl ether for extraction. The extracted substance was concentrated to give 0.23 g of 3-vinyl-2,2,5,5-tetramethylpyrroline-1-oxyl which is a pyrroline nitroxide compound represented by Formula (1) in the form of orange oil.

Because of the following properties, the obtained pyrroline nitroxide compound could be identified. NMR was measured by reducing the radical site with phenylhydrazine.

¹H NMR (CDCl₃): 6.16, 5.60, 5.41, 5.11, 1.39, 1.25 ppm

¹³C NMR (CDCl₃): 131.3, 130.2, 115.1, 113.7, 69.8, 67.3, 25.3, 24.6 ppm

IR (KBr): 2974, 1635, 1593 cm⁻¹

Molecular mass (Mass analysis by atmospheric pressure ionization methods): 166

### PRODUCTION EXAMPLE 2

A 500-mL four-neck flask equipped with a stirrer, a nitrogen-gas inlet tube, a thermometer, and a reflux condenser tube was charged with 70.0 g (311 mmol) of 2,2,6,6-tetramethyl-4-piperidinyl methacrylate and 150 mL of tetrahydrofuran. While the obtained homogenous solution was maintained at 25° C., oxygen inside the reaction system was removed by purging with nitrogen gas. The solution was added with 0.358 g (2.2 mmol) of α,α′-azobisisobutylonitrile as a polymerization initiator and reacted for six hours at 50° C. under stirring. After the reaction completion, the reaction liquid was cooled to room temperature and added to 2,000 mL of hexane. The resulting liquid was filtered to give a polymethacrylic acid imino compound. After rinsed with 500 mL of hexane, the obtained polymethacrylic acid imino compound was dried under reduced pressure to give 69.5 g of the polymethacrylic acid imino compound in the form of white powder.

Subsequently, 18 g of the obtained polymethacrylic acid imino compound and 180 g of chloroform were fed to a 500-mL four-neck flask equipped with a stirrer, a thermometer, a reflux condenser tube, and a dropping funnel, and dissolved. Then, 120 g of 60 wt % aqueous hydrogen peroxide dissolving 0.24 g of sodium tungstate dihydrate therein was dropped thereto over a five hour period. After completion of the dropping, the reaction was continued for 10 hours. After the reaction, the solution was allowed to stand for one hour so that an organic phase was separated. A chloroform phase was removed therefrom. The residual solids were crashed and the resulting powder was dried under reduced pressure to give 15.7 g of polymethacrylic acid nitroxide compound.

### EXAMPLE 1

### Production of Pyrroline Nitroxide Polymer

An amount of 0.17 g (1 mmol) of a pyrroline nitroxide compound obtained in the same manner as in Production Example 1 was fed to a 5-mL eggplant flask equipped with a stirrer and an argon-gas inlet tube. While the temperature of the solution was maintained at 25° C., oxygen inside the reaction system was removed by purging with argon gas. Next, the solution was added with 0.13 mg (0.0006 mmol) of cyclopentadienyltitanium (IV) trichloride and 11.25 mg (0.194 mmol) of methylaminoxan as polymerization initiators. Under argon atmosphere, the mixture was polymerized under stirring at 25° C. for 22 hours. Then, an appropriate amount of methanol was added thereto to terminate the reaction. After completion of the reaction, the reaction mixture was added to 50 mL of hexane. After filtering, the reaction mixture was rinsed with 10 mL of hexane and dried under reduced pressure to give 0.02 g of a light-brown pyrroline nitroxide polymer (yield 11%).

The number average molecular weight of the obtained pyrroline nitroxide polymer was 26,000. The number average molecular weight was measured in N,N-dimethylformamide containing LiCl (0.01 mol/L) and H₃PO₄ (0.02 mol/L) at 30° C. with use of a gel permeation chromatography (product of Shimazu Corporation) and determined based on the standard polystyrene.

### EXAMPLE 2

### Production or Pyrroline Nitroxide Polymer

An amount of 0.03 g of a light-brown pyrroline nitroxide polymer (yield 17%) was obtained in the same manner as in Example 1, except that the polymerization temperature was 50° C.

The number average molecular weight of the obtained pyrroline nitroxide polymer was 21,000. The number average molecular weight was measured in N,N-dimethylformamide containing LiCl (0.01 mol/L) and H₃PO₄ (0.02 mol/L) at 30° C. with use of a gel permeation chromatography (product of Shimazu Corporation) and determined based on the standard polystyrene.

### EXAMPLE 3

### Redox Property of Electrode Containing Pyrroline Nitroxide Polymer

An amount of 0.01 g of the pyrroline nitroxide polymers obtained in Example 1, 0.08 g of vapor-grown carbon fiber as an auxiliary conductive material, and 0.01 g of polyvinilidene fluoride as a binding agent were measured out and mixed. N-methylpyrrolidone was added thereto and kneaded in an agate mortar. A slurry mixture obtained through wet-mixing for about 10 minutes was applied on an ITO substrate and dried in vacuo overnight at 60° C. to produce an electrode.

The cyclic voltammogram of this electrode in a range of potential sweep of 0.5 to 10 V (vs. Ag/AgCl) was measured. In this measurement, a counter electrode was a platinum coil, a reference electrode was Ag/AgCl, and an electrolyte solution was a 0.5M (C₄H₉)₄NClO₄ acetonitrile solution. The measurement clarified appearance of a redox wave derived from p-type redox of nitroxide radical at 0.75 V (vs. Ag/AgCl). The redox wave was stable even with repetitive sweeps.

### EXAMPLE 4

### Cell Utilizing Electrode Active Material Containing Pyrroline Nitroxide Polymer

An amount of 0.01 g of the pyrroline nitroxide polymer obtained in Example 1, 0.08 g of vapor-grown carbon fiber as an auxiliary conductive material, and 0.01 g of polyvinilidene fluoride as a binding agent were measured out and mixed. N-methylpyrrolidone was added thereto and kneaded in an agate mortar. A slurry mixture obtained through wet-mixing for about 10 minutes was applied on an aluminum foil and spread. The slurry was dried in vacuo overnight at 60° C. A 12-mm diameter circle was punched from the dried substance as a coin electrode. The mass of the electrode was 13.0 mg.

The obtained electrode was immersed in an electrolyte to have a void in the electrode impregnated with the electrolyte. The used electrolyte was an ethylene carbonate/diethyl carbonate mixed solution (mixing ratio by mass 1:1) containing 1.0 mol/L of LiPF₆ electrolyte salt. The electrode impregnated with the electrolyte was placed on a stainless steel covering (product of Hohsen Corporation) also serving as a cathode current collector. A polypropylene porous film separator similarly impregnated with the electrolyte was stacked thereon. Then, a lithium disk serving as an anode was stacked, and an anode-side stainless steel covering (product of Hohsen Corporation) was further stacked with an insulating gasket placed along the periphery of the stack. A pressure was applied to the stack using a caulking device. Thus, a sealed coin battery was produced which utilizes the pyrroline nitroxide polymers obtained in Example 1 as a cathode active material and a metallic lithium as an anode active material.

The cyclic voltammogram of this coin cell in a range of potential sweep of 3.2 to 4.2 V was measured. The measurement clarified appearance of a redox wave derived from p-type redox of nitroxide radical at 3.65 V. The redox wave was stable even with repetitive sweeps. In addition, measurement of a charge/discharge curve at a constant current of 0.1 mA (current density 150 μA/cm²) clarified appearance of a plateau potential at 3.64 V and stable charge/discharge activity without significant capacity decrease even after 500 cycles. The capacity per radical material obtained from the charge/discharge curve was 140 mAh/g.

### COMPARATIVE EXAMPLE 1

A coin battery was produced in the same manner as in Example 4, except that 0.01 g of the polymethacrylic acid nitroxide compound obtained in Production Example 2 was used instead of 0.01 g of the pyrroline nitroxide polymer obtained in Example 1.

The charge/discharge curve of the obtained coin battery was measured in the same manner as in Example 4. The capacity per radical material obtained from the charge/discharge curve was 54 mAh/g.

### INDUSTRIAL APPLICABILITY

The present invention provides a pyrroline nitroxide polymer usable as an electrode material of a cell that is capable of providing large current and is subject to smaller capacity decrease even after repetitive charge and discharge, an electrode active material containing the polymer, and a cell utilizing the electrode active material.

### EXPLANATION OF SYMBOLS

1 Stainless steel covering
2 Insulating gasket
3 Anode
4 Separator
5 Cathode
6 Cathode current collector

1. A pyrroline nitroxide polymer obtainable by polymerization of a pyrroline nitroxide compound represented by Formula (1).

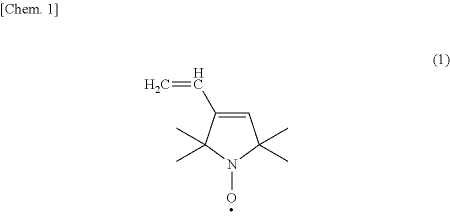

2. A pyrroline nitroxide polymer having a number average molecular weight of 500 to 5,000,000.

3. An electrode active material containing the pyrroline nitroxide polymer according to claim 1.

4. A cell utilizing the electrode active material according to claim 3.

5. An electrode active material containing the pyrroline nitroxide polymer according to claim 2.
